(19) United States
(12) Patent Application Publication
(10) Pub. No.: US 2024/0246030 A1
(43) Pub. Date: Jul. 25, 2024

(54) Hybrid Gas Treatment and Clean Energy Recovery and Storage System

(71) Applicant: Alexander Daniel Bush, Point Lookout, NY (US)

(72) Inventor: Alexander Daniel Bush, Point Lookout, NY (US)

(21) Appl. No.: 18/099,959

(22) Filed: Jan. 22, 2023

(51) Int. Cl. B01D 53/78; B01D 53/34; G06Q 50/06

(52) U.S. Cl. CPC B01D 53/78; B01D 53/343; B01D 53/346; G06Q 50/06; B01D 2259/124

(57) ABSTRACT

The disclosure relates to a hybrid gas treatment and energy recovery system. The system compresses, cools and scrubs the gasses all in one step. This hybrid gas treatment and energy recovery system may be used for exhaust gas scrubbing, odor control and direct air capture applications. Another unique aspect of this invention is the ability to be used as an energy storage system, using renewable energy to compress and clean gas, and then releasing the compressed gas through a gas turbine to recover the stored energy. The system may be implemented on land or at sea.

### BACKGROUND OF THE INVENTION

### Technical Field

The disclosure relates to an exhaust gas treatment system with energy recovery and more particularly to a hybrid exhaust gas treatment and energy recovery and storage system.

### Background

Many countries in the world strive to meet the net zero carbon emission targets that countries committed to in the Paris Agreement on Climate Change. The energy sector as a whole currently accounts for around three quarters of all the greenhouse gases emitted by human activity. To cut those emissions, exhaust gas treatment technologies and green electricity will need central to a climate protection strategy. Thermal generation systems and other industrial activity pollutes the air and contribute directly to the main cause of climate change. By improving existing exhaust gas treatment systems air pollution can be stopped at it's source. Due to the intermittency of renewable electricity generation solutions Energy storage technology must be used to optimize the use of these resources. Pumped Hydro storage is the leading grid scale energy storage technology. Due to it's maturity and geographic constraints a technological improvement is needed.

Therefore, there is a need to provide a new hybrid exhaust gas treatment and clean energy storage system to solve the above technical problems.

### BRIEF SUMMARY OF THE INVENTION

The disclosure relates to a gas treatment system with energy recovery and more particularly to a hybrid gas treatment and clean energy storage system. Wherein a hydraulic pump forces water through an venturi pump entraining a gas within a suction chamber. As the gaseous fluid and liquid fluid mix, gasses react with and dissolve within the liquid fluid. The mixture is released into a large expansion chamber, wherein some of the gasses will separate from the liquid. The chamber 111 pressurizes over time. The compressed gasses may then be used to recover energy via a gas turbine or used in another form of energy recovery such as refrigeration, air conditioning, source for compressed air tools or other form of compressed gas use. The liquid fluid may also be used to recover energy releasing the pressurized water through a pressure exchanger 116 or other energy recovery system such as a turbo charger or hydroelectric turbine.

In the case wherein the system operates as an energy storage system, the electricity used to run the hydraulic pump may be sourced from surplus electricity from renewables such as wind, solar, nuclear or others. Energy may also be stored using on site electricity generated from thermal generation of fossil fuels. Energy is therefore stored in the form of compressed air as a result of the scrubbing process. When energy is demanded the electricity may be recovered by releasing either the compressed gas through a turbine or releasing the pressurized liquid fluid through a turbine and into a secondary reservoir.

Other aspects, features, and advantages will be apparent from the description, the drawings, and the claims that follow.

### BRIEF DESCRIPTION OF THE SEVERAL VIEWS OF THE DRAWING

The accompanying drawings, which are incorporated in and constitute a part of this specification, illustrate aspects of the disclosure and, together with a general description of the disclosure given above and the detailed description given below, serve to explain the principles of this disclosure, wherein:

FIG. 1. is a diagram illustrating the hybrid gas treatment and energy recovery system, in accordance with aspects of the disclosure;

FIG. 2. is a diagram illustrating an alternative embodiment of the hybrid gas treatment and energy recovery system of FIG. 1. with energy storage, in accordance with aspects of the disclosure;

FIG. 3. is a diagram illustrating the hybrid gas treatment and energy recovery system of FIG. 1. with a plurality of sequential scrubbing stages, in accordance with aspects of the disclosure;

FIG. 4 is a diagram illustrating the hybrid gas treatment and energy recovery system of FIG. 1. designed for direct air capture and energy storage, in accordance with aspects of the disclosure;

FIG. 5. is a flow diagram illustrating the operation of the hybrid gas treatment and energy recovery system of the disclosure, in accordance with aspects of the disclosure;

FIG. 6. is a an extension of the flow diagram of FIG. 5. illustrating the operations of the hybrid gas treatment and energy recovery system of the disclosure, in accordance with aspects of the disclosure;

FIG. 7. is a flow diagram demonstrating the control system and operations of the hybrid gas scrubber from FIG. 1. and FIG. 2.

FIG. 9. is a flow diagram illustrating the methods of operation of the hybrid gas treatment and energy recovery system of FIG. 2., in accordance with aspects of the disclosure;

FIG. 8. is a flow diagram illustrating the methods of turning the scrubber or storing gas pre scrub given in response to different event triggers of the hybrid gas treatment and energy recovery system of the disclosure, in accordance with aspects of the disclosure;

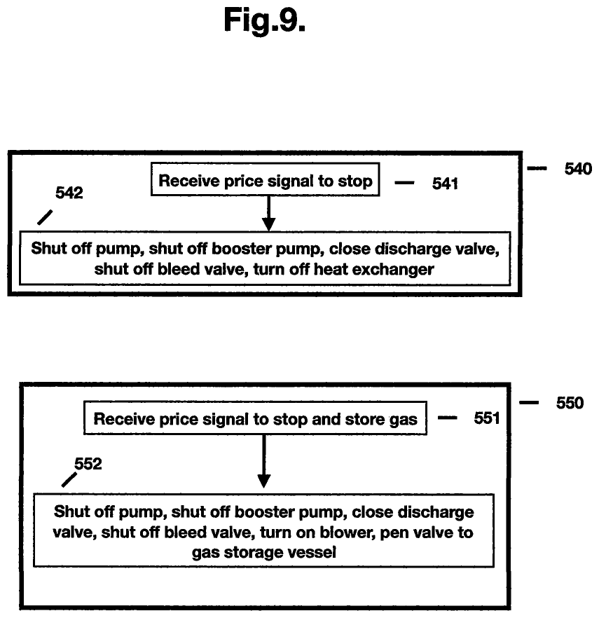

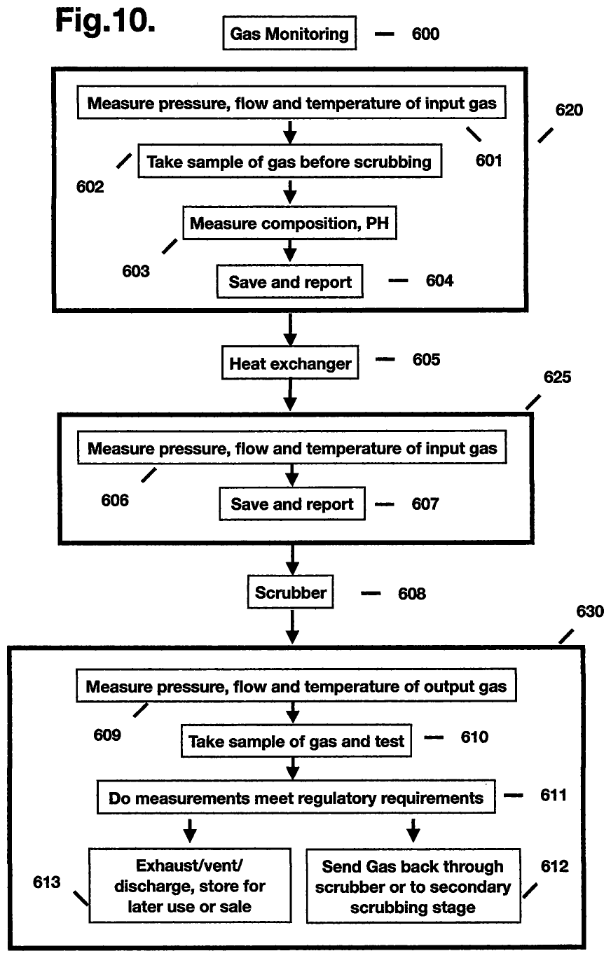

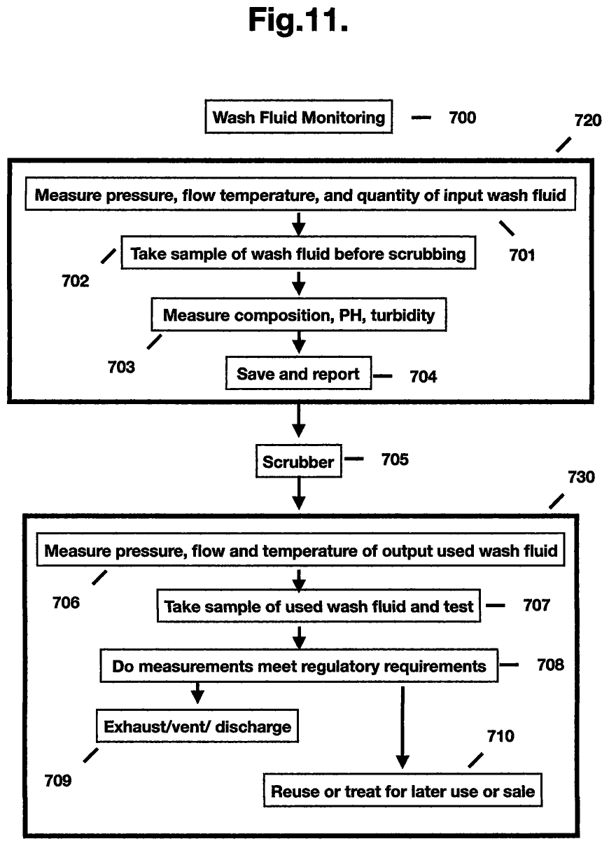

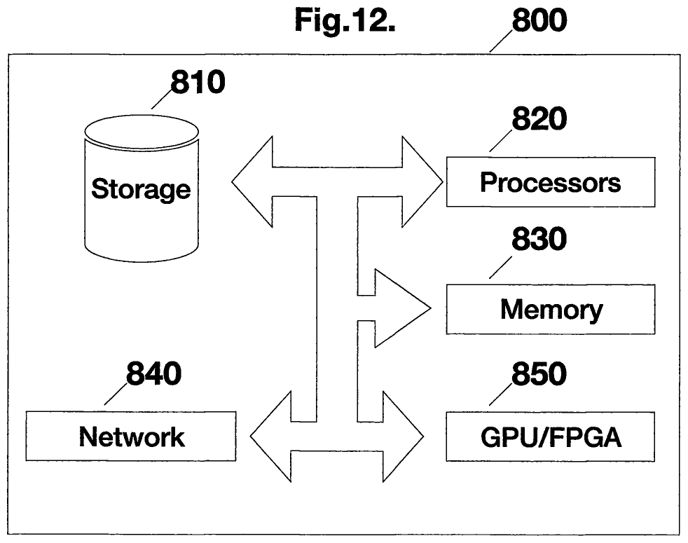

FIG. 9. is a flow diagram illustrating the methods of shutting off the scrubber in response to two different event triggers of the hybrid gas treatment and energy recovery system of The disclosure, in accordance with aspects of the disclosure;

FIG. 10. is a flow diagram illustrating the gas monitoring system of the hybrid gas treatment and energy recovery system of The disclosure, in accordance with aspects of the disclosure;

FIG. 11. is a flow diagram illustrating the wash fluid monitoring system of the hybrid gas treatment and energy recovery system of The disclosure, in accordance with aspects of the disclosure;

FIG. 12. is a block diagram of a controller configured for use with the hybrid gas treatment and energy recovery system of The disclosure, in accordance with aspects of the disclosure.

### SPECIFICATION

This disclosure relates to a gas treatment system with energy recovery and more particularly to a hybrid gas treatment and energy storage system.

Aspects of the disclosed systems are described in detail with reference to the drawings, in which like reference numerals designate identical or corresponding elements in each of the several views. Directional terms such as upper, lower, and the like are used simply for convenience of description and are not intended to limit the disclosure attached hereto. Like terms such as high, low, hot, cold, clean, dirty and the like are used simply for convenience of description and are not intended to limit the disclosure attached hereto.

In the following description, well-known functions or constructions are not described in detail to avoid obscuring the present disclosure in unnecessary detail.

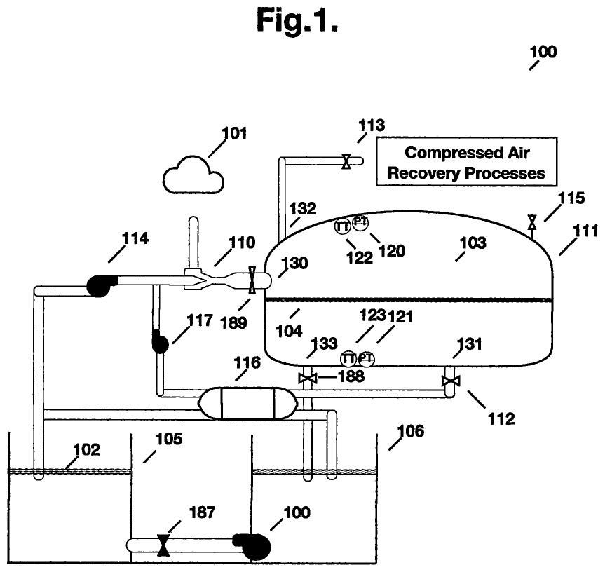

Referring to FIG. 1. a diagram of an embodiment of the disclosure: This figure is an example embodiment of the disclosure which generally consists of a gas 101 which needs to be cleaned or refined, a scrubber 100 wherein a hydraulic pump 114, pumps a wash fluid 102 through a venturi pump 110; commonly referred to as a jet pump or ejector pump. The wash fluid 102 which acts as the motive fluid, which entrains the gas 101 and mixes said gas 101 with said wash fluid 102, scrubbing the gas 101 and releasing the mixture into a chamber 111, wherein the scrubbed gasses 103 expand and release into a chamber 111.

The gas pressure and liquid fluid level may be carefully controlled using a plurality of transmitters and a control system 800. Discharging used wash fluid 104 at a given pressure and flow rate with a back pressure valve 112, and bleeding scrubbed gasses 103 out at a given pressure and flow rate using a valve 113. Discharge rates are calculated relative to the incoming wash fluid 102 and gas 101 entering the chamber 111. The chamber's 111 liquid fluid level is carefully controlled setting predetermined level and drawdown limits. The chamber 111 has an inlet orifice 130 connected to the Venturi pump 110, an outlet orifice 131 for releasing the used wash fluid 104, and an outlet orifice 132 for bleeding out the scrubbed gasses 103 within the chamber 111.

The chamber 111 may be comprised of a man made storage vessel made of steel, carbon steel, pvc, plastic polymers, natural rock formation, converted abandoned mine shaft or other storage vessel known to those skilled in the art. The chamber 111 may include but not limited to an emergency relief valve 115 to expel scrubbed gas 103 from the chamber 111 to prevent damage and explosions, an emergency drain valve 133 to control liquid fluid level and pressure within the chamber 111. The chamber 111 may be primed by pressurizing the chamber 111 with a clean gas to a predetermined threshold. The tank may also be primed by filling the chamber 111 with a liquid fluid to a given level before operation.

The chamber 111 may also include an outlet orifice 131 to discharge the used wash fluid 104, into an energy recovery device designed to recover hydraulic energy. The high pressure discharge stream may be fed into a pressure exchanger 116 used to pressurize the low pressure input steam of wash fluid 102, which may be fed into a booster pump 117 and pumped into the scrubber 100. Alternative methods of energy recovery may also be used including but not limited to a turbo charger wherein the discharged wash fluid 104 is released through a turbine whose shaft is coupled to the pump 118 used to pump the wash fluid 102 into the venturi pump 110. Alternatively the disclosure may be designed wherein the discharge fluid is released through a turbine connected to a generator, which converts the kinetic energy into electrical energy. Other common methods of energy recovery known to those skilled in the art may also be implemented without departing from the scope and essence of the disclosure.

The Wash Fluid 102 is pumped into the venturi pump 110 using a hydraulic pump 114 according to this embodiment of the disclosure a centrifugal pump is used, supplemented by a booster pump 117. The booster pump 117 may also be centrifugal pumps or other known pump type known to those skilled in the art. The main hydraulic pump 114 is fed a liquid fluid from a liquid fluid reservoir 105; the wash fluid 102. The booster pump 117 is fed a higher pressure stream of wash fluid from said liquid fluid reservoir 105 after passing through the pressure exchanger 116. According to the embodiment of the disclosure herein FIG. 1. the system is designed as a closed loop system wherein the used wash fluid 104 may be discharged into a treatment tank 106, wherein it will undergo a treatment before returning to the wash fluid reservoir 105. Treatments may consist of chemical, thermal, bioremediation or other method of treatment known to those skilled in the art without departing from the scope of the disclosure. In other aspects of the disclosure, the system may operate as an open loop system drawing from and discharging to the same liquid fluid reservoir or an offsite treatment facility, or a hybrid system without departing from the scope of the disclosure.

The chamber 111 may also include a gas line and valve 113, connecting the chamber 111 to an energy recovery system and or a gas storage vessel designed to release a set pressure and flow of scrubbed gas 103 into said pressure vessel 141 or energy recovery application. The pressure vessel 141 may be used to store the gas until needed for on site use in refrigeration, cooling, air conditioning, compressed air tools, sealing air, ballast operations, energy recovery for onsite consumption or selling to the grid by releasing the pressurized gasses through a gas turbine, or any other form of recovery through the use of compressed air. Gasses may also simply be vented into the atmosphere.

The system may be implemented on land or at sea on ships, submarines and other aquatic vessels. The system may be configured to handle exhaust gas from thermal generation power plants, waste gasses from waste water treatment plants, waste gas from composting facilities, waste gas from the chemical industry, atmospheric gasses or any other gas stream.

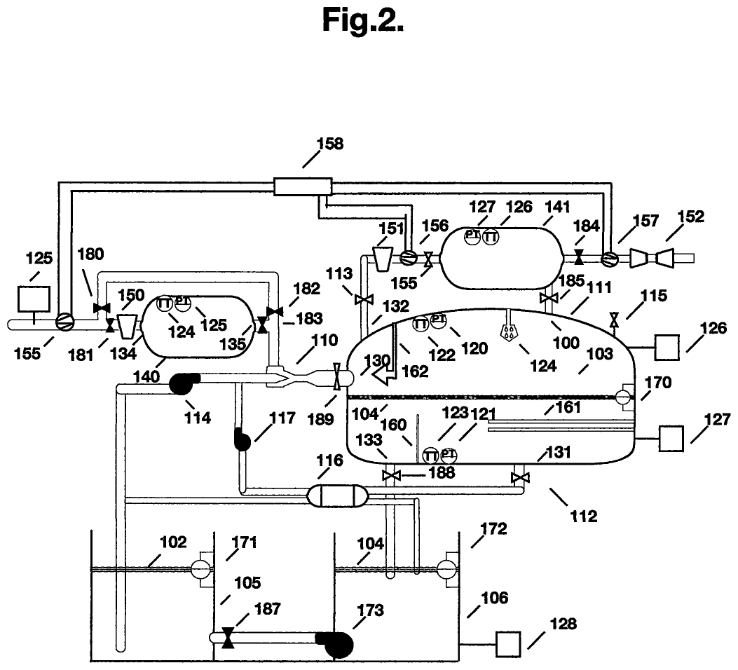

Referring to FIG. 2. a diagram of an alternative embodiment of the disclosure. According to other aspects of the disclosure the chamber 111 may also include a baffle 160 to separate solids, a sacrificial anode 161 used to prevent corrosion of the chamber 111 and other pieces of equipment by corroding itself, a pressure transmitter 120 to measure pressure of the scrubbed gas 103 within the chamber 111, a secondary pressure transmitter 121 used to measure the pressure of the used wash fluid 104 in the chamber 111, a temperature transmitter 122 used to measure the gas 103 temperature within the chamber 111, a secondary temperature sensor 123 to measure the temperature of the used wash fluid 104 within the chamber 111, a humidity transmitter 124 used to measure the humidity of the gas 103, a level sensor to measure the liquid fluid level 170 within the chamber 111, a level sensor 171 within the wash fluid reservoir 105 to measure amount of wash fluid available, a level sensor 172 within the treatment reservoir 106 to measure amount of used wash fluid in the treatment reservoir, a gas quality transmitter 125 used to sample and measure the initial quality of the input gas used to measure temperature, composition, quality, pressure and flow, a gas quality transmitter 126 used to sample and measure the gas composition and quality of the scrubbed gas 103 within the chamber 111, a liquid fluid quality transmitter 127 designed to sample and test the quality of the input wash fluid 102 measuring ph, composition, turbidity and other measurements relevant to goals or regulations, a liquid fluid quality sensor 128 designed to measure ph, composition, turbidity and other measurements relevant to goals or regulations of the wash fluid 104 within the chamber 111, a liquid fluid quality sensor 129 designed to measure ph, composition, turbidity and other measurements relevant to goals or regulations of the used wash fluid 104 within the treatment reservoir 106.

Treatment reservoirs 106 may include a pump(173) to cycle the recovered used wash fluid 104 back into the initial wash fluid reservoir 105. The scrubber 100 may also include a splash plate 162 designed to help release the gasses 103 into the chamber 111. The splash plate 162 may be iron, limestone, carbon steel or other material known to those skilled in the art.

In aspects of the disclosure the system may have an additional gas storage vessel 140 for storing a gas 101 temporarily before scrubbing. A low pressure blower 150 may be used to fill the gas storage vessel vessel 140. An inlet 134 for the gas 101, and an outlet 135 to release the gas 101 to the scrubber 100. The gas storage vessel 140 may include but is not limited to a temperature transmitter 124 and a pressure transmitter 125 to measure and control the gas storage vessel 140. Gasses may be stored in said gas storage vessel 140 prior to scrubbing during high energy prices. The gasses may then be scrubbed during periods of low demand and low prices. Electricity may be bought from the grid from renewable energy generation sources.

According to this embodiment the disclosure, pressurized scrubbed gas 103 from within the chamber 111 is bled out through valve 113 and stored in a gas storage vessel 141. According to aspects of the disclosure the compressed scrubbed gas 103 may be used in a variety of applications including but not limited to energy recovery through electricity generation expanding the scrubbed gas 103 through a turbine 152, air conditioning, refrigeration, compressed air tools, or any other use for compressed air known to those skilled in the art. According to this embodiment the heat may be recovered by preheating the stored compressed gas before recovering the energy in one of the many options available. In aspects of the disclosure as shown herein FIG. 2. the system may also include a compressor 151 used to further compress the scrubbed gas 103 from the chamber 111 before storing the gas 103 within a storage vessel 141, a heat exchanger 156 may be used to capture and store the heat produced during compression, a second heat exchanger 157 used to preheat the gasses during generation by releasing the gasses from the storage vessel 141 through a gas turbine 152. Heat may be stored in a thermal storage medium within a thermal storage vessel 158.

In other aspects of the disclosure the system may blowout the chamber 111 for regular maintenance. According to the disclosure the gas 103 from the storage vessel 141 may be released back into the chamber 111 forcing the used wash fluid fluid 104 out through an orifice 133 connecting the chamber 111 and a reservoir 106. In some aspects of the disclosure discharged wash fluid 104 may be passed through a turbine used to recover energy. The chamber 111 also includes another outlet 133 for draining solids and large particulates out of the chamber 111 and directly into the treatment tank 106. In other aspects of the disclosure the used wash fluid 104 may also be discarded to a local off site water treatment plant.

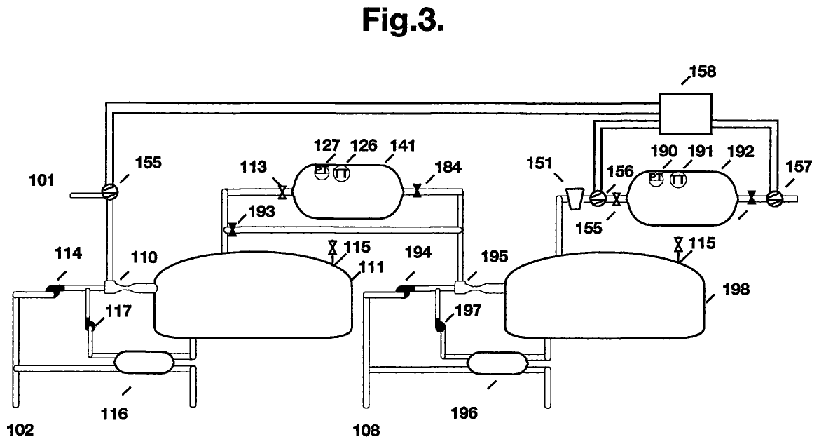

Referring to FIG. 3. a diagram of an embodiment of the disclosure with two stages of scrubbing. In aspects of the disclosure the system may be arranged in two stages, wherein the system 100 runs in a sequence. First scrubbing gasses with one wash fluid 102, then further scrubbing the gasses using another wash fluid 108. according to this embodiment of the disclosure the first stage of the system uses water as the wash fluid 102, and an amine solution specifically; a monoethalymine and water solution for the second stage of scrubbing to scrub out and capture the carbon dioxide. The initial stage removes the sulfur and heavy particulates from the gas stream. This helps improve the efficiency of the second stage and protect the parts from the particulates and corrosive gasses scrubbed in the first stage. According to this embodiment of the disclosure gasses from the first stage of scrubbing may be released directly into the second stage and or stored in a pressure vessel 141 before being released into the second stage of scrubbing.

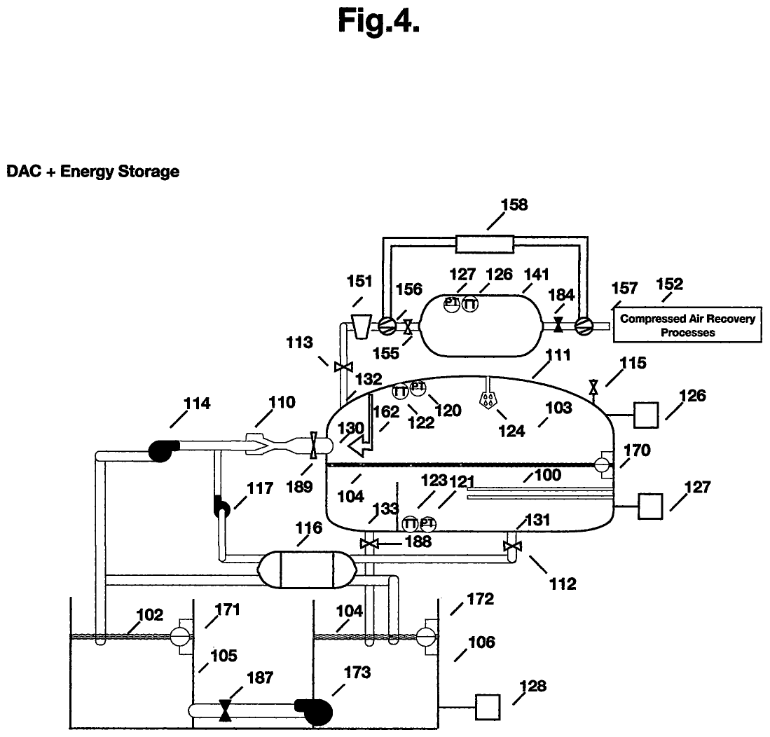

Referring to FIG. 4. a diagram of an embodiment of the disclosure wherein the scrubber acts a hybrid energy storage and direct air capture system. According to this embodiment of the disclosure the system is designed for direct air capture of carbon dioxide. According to this embodiment the wash fluid 102 used is a monethalymine amine solution. The wash fluid 102 is pumped through the venturi pump 110 entraining atmospheric air 101. The solution captures the carbon dioxide along with dust, pollen other solid particulates and gasses such as sulfurs and hydrogen sulfide. As a result the system 100 builds up a supply of cool dry compressed air. The pressurized air 103 may be used for energy storage, recovering the energy used by releasing the gasses through a gas turbine 152. According to the embodiment of the disclosure an air compressor 151 may be used to further compress the gasses from the chamber 111 and store the gas 103 within a secondary gas storage vessel 141. The system may also include a heat exchanger 156 used to capture and store the waste heat generated during compression. A secondary heat exchanger 157 may be used to recover the waste heat energy during generation by preheating the gasses before releasing them through said gas turbine 152. According to other aspects of the disclosure the gasses may alternatively be used within an air separation plant, to separate nitrogen, argon and oxygen. Alternatively the gasses may be used for a variety of other purposes including but not limited to air conditioning, refrigeration, compressed air tools, or any other use for compressed air known to those skilled in the art. The carbon dioxide removed may be recovered from the amine solution by heating the solution.

According to aspects of the disclosure the system may be operated as an energy storage system wherein the energy used to scrub and compress atmospheric gas is generated by renewable energy generators such as wind, solar, hydro or others. The resulting compressed gas is bled out from the chamber 111 and stored within an external gas storage vessel 141. According to the disclosure a plurality of gas storage vessels may also be used store the gas 103 without departing from the scope of the disclosure. Gas storage vessels may be man made steel vessels or other material commonly used for constructing man made gas storage vessels, or any natural cavity in the earth such as a salt cavern, aquifer, rock cavity or other type of vessel known to those skilled in the art without departing from the disclosure. Then when energy is demanded the gasses may be released through a gas turbine( ) used to convert the kinetic energy into electricity.

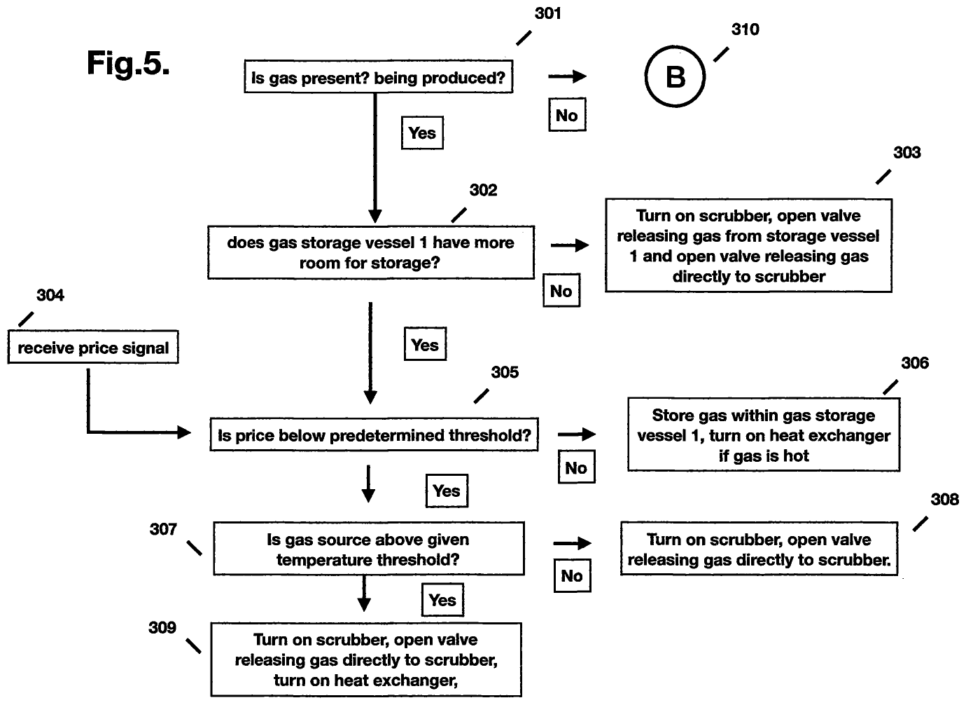

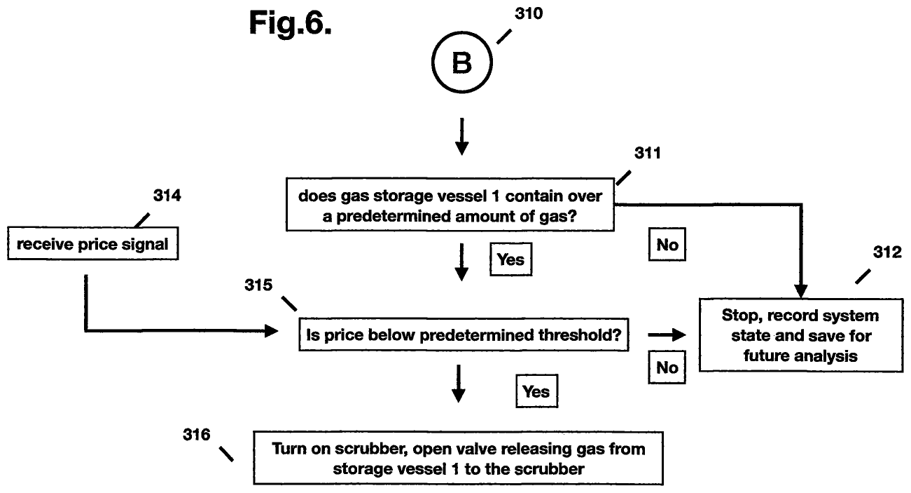

referring to FIG. 5. and FIG. 6. a flow diagram illustrating the operation of the hybrid gas treatment and energy recovery system of FIG. 1, in accordance with aspects of the disclosure. According to the flow diagram system 100 may initially check if gas is being produced. Then if a gas storage vessel is available check if gas storage vessel has more room available to store excess gas. If there is no gas storage available and gas is being produced the gas scrubber must be turned on regardless of current energy prices. If more gas may be stored within the gas storage vessel, move on to step 3 wherein a price signal is received from the grid reflecting the price of electricity. If the price is below a predetermined threshold turn on the scrubber and scrub the gasses being produced. If gas within the gas storage vessel( ) is above a predetermined threshold then open the valve( ) to the gas storage vessel( ) and scrub the stored gasses as well. If price is above a given threshold, and gas storage is available then store the gas being produced in a gas storage vessel. If gas is hot then turn on heat exchanger( ) to cool gas before scrubbing or storage.

FIG. 6. is an extension of the flow diagram from FIG. 5. wherein gas is not being produced. If gas is not being produced then check gas storage vessel's status. If gas within the storage vessel is above a predetermined threshold, then check the price of electricity, if electricity prices are below a predetermined threshold then turn on the scrubber and scrub the gasses stored within the gas storage vessel, if prices are above predetermined level then remain off, and save system state for future analysis.

Price threshold may be calculated using algorithms designed to minimize the cost of scrubbing. Using a price prediction model, prices throughout a given time period may be predicted. Then using a separate model to predict the energy usage and time needed to scrub the amount of gas produced during a given period of time the algorithm may calculate an operating schedule to minimize the cost of scrubbing over a given time period.

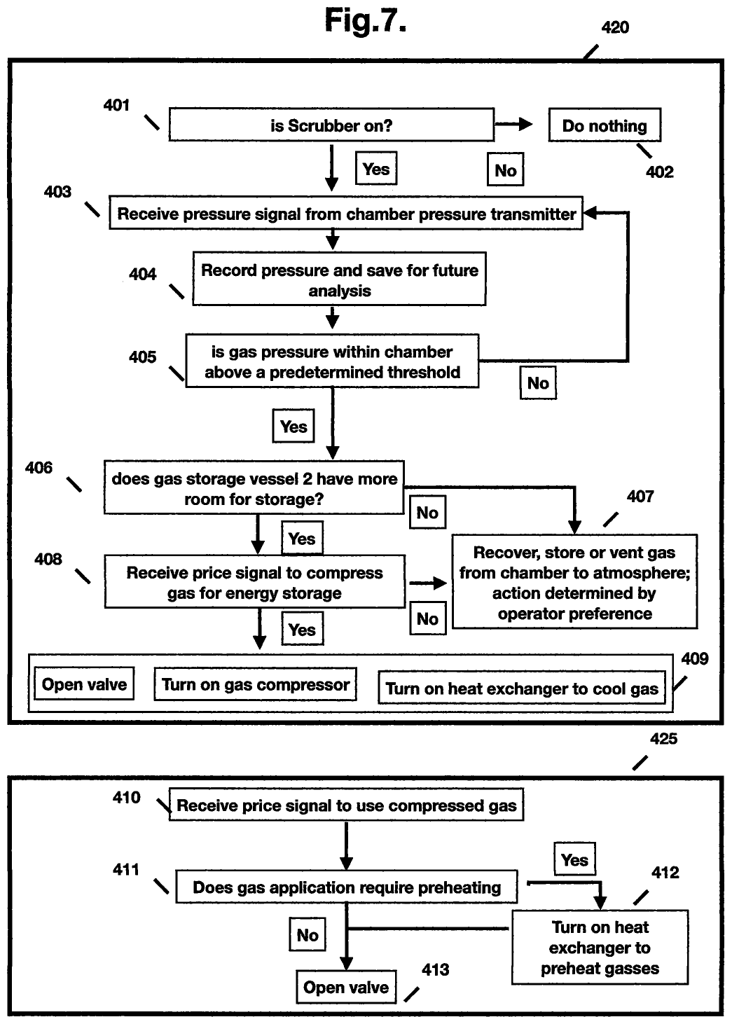

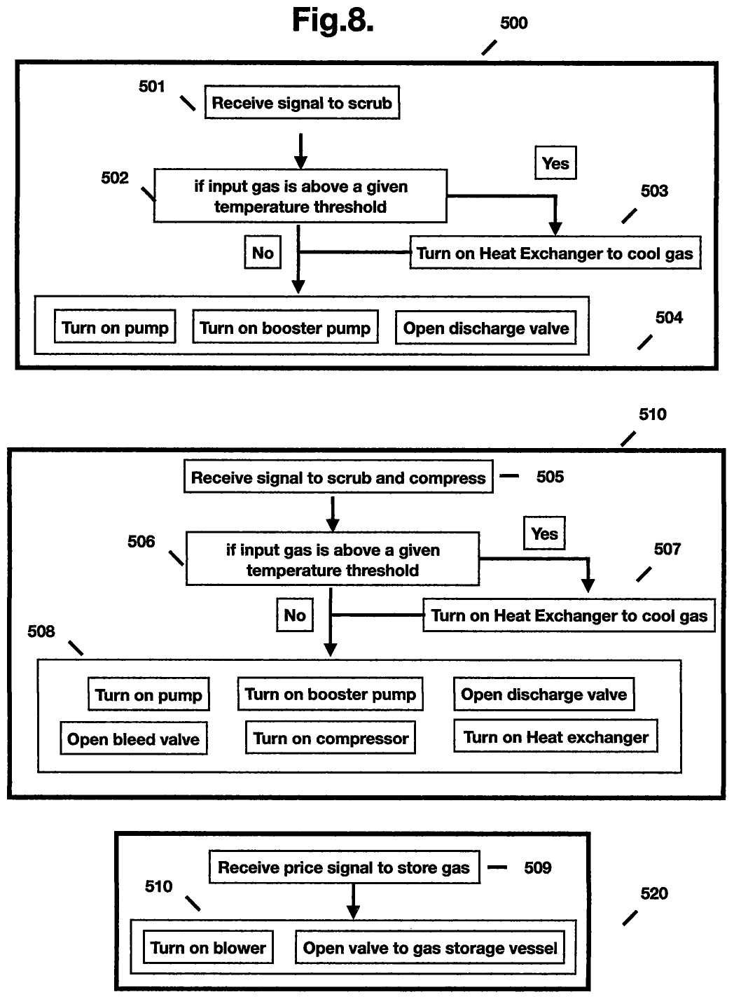

Referring to FIG. 7. a flow diagram demonstrating the operations of the scrubber. According to this flow diagram of the disclosure the system is operating as an energy storage system; which compressed the scrubbed gas using low cost electricity, and then recovers the energy and sells it back to the grid during peak periods with high cost electricity, first check if the scrubber is on. If scrubber is off, do nothing and repeat step 1. If the scrubber is on, then receive pressure signal from the chamber's pressure transmitter. Next the pressure signal is recorded and saved for future analysis. If gas pressure within the chamber is above a given threshold the system checks the status of the scrubber to see if it is on or off. If gas pressure is below a given pressure threshold return to step 2. If gas pressure within the chamber is above a given threshold then check status of gas storage vessel 2 used to stored high pressure scrubbed gasses. If storage is unavailable the gasses may be vented to the atmosphere, used on site for industrial applications, stored in other available storage vessels, sold or used for other applications the operator may choose. If storage is available, return storage availability and record system state for future analysis, receive and check price signal from the grid, if prices are below a given level scrub gasses and compress the scrubbed gasses further using a gas compressor, cool the gasses using a heat exchanger and ultimately store the gasses within gas storage vessel 2. If prices are above a predetermined level then the gasses may be vented to the atmosphere, used on site for industrial applications, stored in other storage vessels and sold or used within other applications the operator may choose.

The flow diagram of FIG. 7. illustrates the system determining when to recover the energy stored in the form of compressed gas. According to this flow diagram the system receives a price signal at or above a predetermined threshold. If recovery method requires preheating of the gas then turn on the heat exchanger to preheat the gasses and open valve. If gas does not require preheating then open the valve and use the compressed gas as needed. In the castoff energy storage gasses may be preheated and released through a gas turbine which converts the potential energy of the compressed gas into electricity.

FIG. 8. and FIG. 9. demonstrate the process of turning on and off the scrubber in response to an on off signal. According to FIG. 8. the scrubber is turned on after receiving the signal to activate. Check gas temperature signal from temperature transmitter. If input gas 101 is at or above a given temperature the heat exchanger is turned on. The scrubber is turned on by turning on the pump, and the booster pump; in the case wherein the energy recovery system uses a pressure exchanger, and the discharge valve is open. If amount of gas stored within gas storage vessel 1 is above a predetermined level open valve connecting gas storage vessel and the scrubber. If gas is being produced open valve releasing gas directly into the scrubber.

According to FIG. 8. when the system receives the signal to scrub and compress the scrubber is turned on following the previous steps described. In addition the gas from the chamber is bled out into the compressor which is turned on, the heat exchanger is turned on and used to cool the gasses before ultimately being stored within a high pressure gas storage vessel.

Referring to FIG. 9. a flow diagram of an embodiment of the disclosure demonstrating the systems method of stopping scrubbing operations. According to the top box 540 of FIG. 9. the flow diagram demonstrates how to shut off the scrubber. After receiving signal to shut off, the pump, booster pump and heat exchanger will all receive a signal to shut off and will be shut off. The discharge valve and bleed valve are sent a signal to close and will be closed.

According to FIG. 9. the flow diagrams demonstrate turning off the scrubber and storing input gas. According to the embodiment of the system, a signal to stop scrubbing and store gas is received. Then the system will shut off pumps to the scrubber close the valve releasing gas to the scrubber and open the valve to the gas storage vessel, turn on a low pressure blower if available. Once gas storage vessel reaches full capacity shut off blower and close valve.

The flow diagram of FIG. 10. demonstrates the monitoring of the gaseous fluid during operation. According to FIG. 10. the input gas may first be sampled and measured before entering the scrubber. Measurements may include but are not limited to pressure, temperature, flow, composition, ph and any other tests known to those skilled in the art may find relevant, results and measurements may be recorded and saved for future analysis.

After passing through the heat exchanger the gas may again measure the temperature, pressure and flow of the gas, measurements may be recorded and saved.

After passing through the scrubber the gasses may again be sampled and tested for temperature, composition, ph and any other tests known to those skilled in the art. If measurements meet regulatory standards gas may be vented, discharged, stored for consumption on site for industrial purposes or sold for future consumption. If gas does not meet standard the gasses may be passed back through the scrubber, or passed through to a secondary scrubber treatment system before being vented to the atmosphere or used. Measure the suction of the gas scrubber/or in other words how much gas is scrubbed per interval of time. The scrubbed gasses within the chamber are also measured for pressure and temperature which may also be used to calculate the amount of gas present in the chamber. Measurements may be saved and recorded for future analysis and reporting.

The flow diagram of FIG. 11. demonstrates the monitoring of the wash fluid. First the wash fluid quantity may be measured. The temperature, composition, ph and turbidity. If wash fluid solutions composition chemicals may be added to the wash fluid to meet the requirements for the wash fluid measurements should be recorded and saved for future analysis and reporting.

After passing through the pump the wash fluids, pressure, temperature and flow may be measured recorded and saved.

After scrubbing the wash fluid may again be sampled and tested for composition, PH, turbidity, temperature and any other variables known to those skilled in the art may. measurements and test results may be saved for future analysis.

FIG. 12. illustrates that controller 800 includes a processor 820 connected to a computer-readable storage medium or a memory 830. The controller 800 may be used to control and/or execute operations of the system 100. The computer-readable storage medium or memory 830 may be a volatile type of memory, e.g., RAM, or a non-volatile type of memory, e.g., flash media, disk media, etc. In various aspects of the disclosure, the processor 820 may be another type of processor, such as a digital signal processor, a microprocessor, an ASIC, a graphics processing unit GPU, a field-programmable gate array FPGA, or a central processing unit CPU. In certain aspects of the disclosure, network inference may also be accomplished in systems that have weights implemented as memristors, chemically, or other inference calculations, as opposed to processors.

In aspects of the disclosure, the memory 830 can be random access memory, read-only memory, magnetic disk memory, solid-state memory, optical disc memory, and/or another type of memory. In some aspects of the disclosure, the memory 830 can be separate from the controller 800 and can communicate with the processor 820 through communication buses of a circuit board and/or through communication cables such as serial ATA cables or other types of cables. The memory 830 includes computer-readable instructions that are executable by the processor 820 to operate the controller 800. In other aspects of the disclosure, the controller 800 may include a network interface 840 to communicate with other computers or to a server. A storage device 810 may be used for storing data.

The disclosed method may run on the controller 800 or on a user device, including, for example, on a mobile device, an IoT device, or a server system.

In some aspects, the term “controller” may be used to indicate a device that controls the transfer of data from a computer or computing device to a peripheral or separate device and vice versa, and/or a mechanical and/or electromechanical device e.g., a lever, knob, etc. that mechanically operates and/or actuates a peripheral or separate device.

In aspects, the controller includes a storage and/or memory device. The storage and/or memory device is one or more physical apparatus used to store data or programs on a temporary or permanent basis. In some aspects, the controller includes volatile memory and requires power to maintain stored information. In various aspects, the controller includes non-volatile memory and retains stored information when it is not powered. In some aspects, the non-volatile memory includes flash memory. In certain aspects, the non-volatile memory includes dynamic random-access memory DRAM. In some aspects, the non-volatile memory includes ferroelectric random-access memory FRAM. In various aspects, the nonvolatile memory includes phase-change random access memory PRAM. In certain aspects, the controller is a storage device including, by way of non-limiting examples, CD-ROMs, DVDs, flash memory devices, magnetic disk drives, magnetic tapes drives, optical disk drives, and cloud computing-based storage. In various aspects, the storage and/or memory device is a combination of devices such as those disclosed herein.

In some aspects, the controller includes a display to send visual information to a user. In various aspects, the display is a cathode ray tube CRT. In various aspects, the display is a liquid crystal display LCD. In certain aspects, the display is a thin film transistor liquid crystal display TFT-LCD. In aspects, the display is an organic light emitting diode OLED display. In certain aspects, on OLED display is a passive-matrix OLED PMOLED or active-matrix OLED AMOLED display. In aspects, the display is a plasma display. In certain aspects, the display is a video projector. In various aspects, the display is interactive e.g., having a touch screen or a sensor such as a camera, a 3D sensor, a LiDAR, a radar, etc. that can detect user interactions/gestures/responses and the like. In some aspects, the display is a combination of devices such as those disclosed herein.

The controller may include or be coupled to a server and/or a network. As used herein, the term “server” includes “computer server,” “central server,” “main server,” and like terms to indicate a computer or device on a network that manages the system, components thereof, and/or resources thereof. As used herein, the term “network” can include any network technology including, for instance, a cellular data network, a wired network, a fiber optic network, a satellite network, and/or an IEEE 802.11a/b/g/n/ac wireless network, among others.

As used herein, the controller includes software modules for managing various aspects and functions of the disclosed system or components thereof.

The disclosed structure may also utilize one or more controllers to receive various information and transform the received information to generate an output. The controller may include any type of computing device, computational circuit, or any type of processor or processing circuit capable of executing a series of instructions that are stored in memory. The controller may include multiple processors and/or multicore central processing units CPUs and may include any type of processor, such as a microprocessor, digital signal processor, microcontroller, programmable logic device PLD, field programmable gate array FPGA, or the like. The controller may also include a memory to store data and/or instructions that, when executed by the one or more processors, cause the one or more processors to perform one or more methods and/or algorithms.

Any of the herein described methods, programs, algorithms and/or codes may be converted to, or expressed in, a programming language or computer program. The terms “programming language” and “computer program,” as used herein, each include any language used to specify instructions to a computer, and include but is not limited to the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state such as source, compiled, object, or linked is a reference to any and all such states. Reference to a program may encompass the actual instructions and/or the intent of those instructions.

Persons skilled in the art will understand that the structures and methods specifically described herein and illustrated in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, it is envisioned that the elements and features illustrated or described in connection with one exemplary aspect may be combined with the elements and features of another without departing from the scope of this disclosure, and that such modifications and variations are also intended to be included within the scope of this disclosure. Indeed, any combination of any of the disclosed elements and features is within the scope of this disclosure. Accordingly, the subject matter of this disclosure is not to be limited by what has been particularly shown and described.

1. A hybrid exhaust gas treatment system with energy recovery and energy storage comprising:
a gaseous fluid;
a liquid fluid to be used as a wash fluid for the gas;
a hydraulic pump used to pump wash fluid through venturi pump;
a booster pump used to pump a high pressure wash fluid stream feed from the pressure exchanger;
a pressure exchanger or other energy recovery method such as a turbo charger, or turbine designed to recover the hydraulic energy of the discharge wash fluid from the chamber;
a venturi pump used to mix the wash fluid and gas together for scrubbing;
a chamber to allow the gasses to release from the wash fluid and pressurize;
a liquid fluid reservoir to store wash fluid;
a back pressure valve designed to provide the resistance necessary to maintain a predetermined pressure threshold within the tank;
a valve to release scrubbed compressed air;
a gas storage vessel to collect, store and distribute compressed gas;
an emergency relief valve to vent chamber.

2. The system of claim 1, wherein the system comprises:
a pressure vessel to store low pressure input gas;
a heat exchanger for cooling input gas and storing waste heat;
a secondary heat exchanger for using the stored heat for preheating compressed gasses during recovery or other thermal recovery process;
a heat storage vessel;
a thermal storage fluid;
a secondary storage vessel for storing input gas at a low pressure until energy prices are below a predetermined threshold or a surplus of renewable energy is available or other contract requirement is met;
a low-pressure blower to fill the gas storage vessel with input gas before scrubbing;
an additional gas storage vessel for storing scrubbed gasses until needed for energy recovery or other industrial applications;
a gas compressor to compress scrubbed gasses after initial stage of scrubbing and compression;
an additional heat exchanger for cooling gasses after compression and storing the waste heat generated;
a gas turbine used to convert the energy of the stored compressed air into electrical energy;
a splash plate for releasing scrubbed gasses from the wash fluid;
a sacrificial anode used to prevent corrosion of essential parts of the system;
a baffle used to separate solids;
an emergency gas relief valve used to prevent over pressurization;
a drain used to drain the liquid fluid in case of an emergency and used for maintenance to drain solids and from the tank;
a treatment tank for the wash fluid;
a secondary pump used to pump treated water back into liquid fluid reservoir;
a control valve used to regulate the pressure and liquid fluid level within the chamber;
a bleed valve used to bleed the compressed air in the tank into a secondary gas storage vessel;
a gas sampler and transmitter to measure the input gas;
a gas sampler and transmitter to measure the output gas;
a liquid sampler and transmitter to measure the quality of the input wash fluid;
a liquid sampler and transmitter to measure the quality of the output used wash fluid;
a treatment reservoir for treating output used wash fluid in closed loop embodiments;

3. Control system for operating the hybrid gas treatment and energy recovery and storage system from claims 1 and 2 wherein;
Electricity prices are modeled and predicted and used to schedule operating times along with a plant model which models gas characteristics including but not limited to quantity over time, pressure, flow, temperature, composition, PH. The plant model also includes a modeling of the systems operating performance capability to effectively schedule operations in order to minimize costs and maximize revenues.
